(19) United States
(12) Patent Application Publication
(10) Pub. No.: US 2016/0374360 A1
(43) Pub. Date: Dec. 29, 2016

(54) MICELLAR CASEIN FOR CORREE CREAMERS AND OTHER DAIRY PRODUCTS

(71) Applicant: Leprino Foods Company, Denver, CO (US)

(72) Inventors: Richard K. Merrill, Highlands Ranch, CO (US); Jiancai Li, Englewood, CO (US)

(73) Assignee: Leprino Foods Company, Denver, CO (US)

(21) Appl. No.: 15/184,717

(22) Filed: Jun. 16, 2016

Related U.S. Application Data
(60) Provisional application No. 62/185,840, filed on Jun. 29, 2015.

(51) Int. Cl. A23C 11/04; A23J 1/20

(52) U.S. Cl. CPC A23C 11/04; A23J 1/202; A23L 33/115; A23L 33/19; A23L 33/16; A23L 33/10; A23V 2002/00

(57) ABSTRACT

Nutritional compositions are described that include a casein compound that includes micellar casein, a vegetable oil, a sweetener, and an acidity regulator, among other ingredients. The nutritional compositions may be used as beverage creamers, such as coffee creamers. Also described are methods of making nutritional compounds that include micellar casein.

### BACKGROUND

Coffee creamers (also called coffee whiteners) were originally commercialized in the 1950s as a longer-lasting, shelf-stable alternative to cream and sugar. Those original creamers were essentially powdered cream and sugar made by heating and removing the water from cream. While powdered cream and sugar was less prone to spoilage than liquid cream, it did not dissolve easily in hot coffee or tea due to the high concentrations of milk proteins and fats. It also contained significant quantities of lactose sugar.

It was later discovered that the poor solubility of creamers made of powdered cream and sugar could be overcome by replacing the milk fat with a vegetable oil and reducing the amount of protein. However, replacing the milk fats and some of the proteins with vegetable oils created new challenges to keep the creamer homogenized (i.e., preventing the vegetable oil from separating from the aqueous-phase ingredients). For liquid creamers this meant keeping the oil and water in the creamer from separating into separate phases to maintain the creamer's shelf stability. Similar challenges occur when adding powdered creamers to beverages that were mostly water, like coffee and tea.

Vegetable oils are also more prone to separating from the water in the creamer or beverage, so emulsifiers are introduced to keep the oil and water phases mixed. A popular class of emulsifiers, casein salts or “caseinates”, are derived from milk proteins. The manufacture of the casein salts may involve contacting acidic casein proteins with an alkaline solution. The alkaline solution deprotonates the casein proteins, and forms the casein salt, which may be left in solution or spray dried to make a caseinate powder. The type of casein salt formed is controlled by the selection of the base in the alkaline solution. For example, sodium hydroxide produces sodium caseinate while calcium hydroxide produces calcium caseinate.

Two casein salts widely used in creamers are calcium caseinate and sodium caseinate. The calcium ion is divalent, allowing it to bond with multiple caseinate anions, and permitting more extensive crosslinking of them. Often the crosslinking will localize the hydrophobic regions of the caseinate ions and make them less effective at penetrating and emulsifying the vegetable oil and other hydrophobic ingredients present in the creamer. In contrast, sodium caseinate uses a monovalent sodium cation that generally produce smaller, less crosslinked casein salts with less localization of the hydrophobic regions. Consequently, sodium caseinate is more soluble in liquid creamers and better able to penetrate fat and oil droplets to form an emulsion. While in many circumstances sodium caseinate is a more effective emulsifier than calcium caseinate, a creamer manufacturer may choose to go with the calcium salt or a blend of calcium and sodium salts. In some instances, the decision to choose the calcium salt may be motivated to increase the calcium content and/or decrease the sodium content of the creamer.

Today, consumers are demanding creamers with less fats and oil, yet no diminishment in the taste and mouthfeel experienced with fresh cream. While casein salts are largely protein, they are not a suitable substitute for the milk fats or vegetable oils used in creamers due to their relatively high solubility in water. They are more likely to form an aqueous solution than a suspension of finely emulsified particles that scatter light to give the creamer a white appearance, and give the creamer an emulsified fat kind of mouthfeel. They also lack noticeable dairy flavors many consumers desire in a cream substitute.

Creamer manufactures have tried to address the deficiencies with casein salts by replacing vegetable oils with low fat and non-fat (i.e., skim) milk concentrates. Unlike the more water soluble casein salts, native milk proteins, particularly casein, form a relatively insoluble colloidal suspension in water such as the fine particles in milk that help create its white appearance and creamy mouthfeel. However, replacing milk fats and vegetable oil in creamers with low or non-fat milk protein concentrates often create the same problems of low water solubility and high lactose levels experienced with the original creamers made from powdered cream and sugar. Thus, there is a need for new creamer ingredients that can increase the nutritional value of creamer without sacrificing convenience, taste, and mouthfeel.

### BRIEF SUMMARY

Micellar casein compositions are described for use in nutritional compositions such as coffee creamers and other dairy products. Unlike water soluble casein salts (e.g., sodium caseinate), the present micellar caseins are insoluble in typical aqueous cold and hot temperature beverages like hot tea, iced tea, hot coffee, iced-coffee, etc. Thus, the micellar caseins form finely emulsified particles that enhance the mouthfeel and increase the whitening ability of a creamer.

The present micellar casein is a native milk protein formed by the direct filtration of milk (e.g., whole milk, low-fat milk, non-fat milk, etc.). The present filtration processes produce a highly purified native micellar casein that disperses rapidly in water and does not suffer from poor aqueous solubility like powdered milks, creams, and undifferentiated milk protein concentrates. The present micellar casein provides excellent taste and mouthfeel to nutritional compositions like creamers, and may also be used to adjust the protein content of the nutritional compositions.

Embodiments of the present nutritional compositions may include a casein compound containing micellar casein, a vegetable oil, a sweetener, and an acidity regulator. The micellar casein may be a native micellar casein formed by the direct filtration of milk.

Embodiments of the present nutritional compositions may also include the following non-exhaustive list of ingredients (with weight percentages on a dry basis):
1 wt. % to 15 wt. % casein compound comprising micellar casein;
10 wt. % to 50 wt. % vegetable oil;
25 wt. % to 70 wt. % sweetener; and
0.5 wt % to 5 wt. % acidity regulator.

Embodiments may further include a coffee creamer that is made from at least an oil and a casein compound that consists essentially of micellar casein. The oil may be a vegetable oil, and the micellar casein may be a native micellar casein formed by the direct filtration of milk.

Additional embodiments and features are set forth in part in the description that follows, and in part will become apparent to those skilled in the art upon examination of the specification or may be learned by the practice of the invention. The features and advantages of the invention may be realized and attained by means of the instrumentalities, combinations, and methods described in the specification.

### BRIEF DESCRIPTION OF THE DRAWINGS

The patent or application file contains at least one drawing executed in color. Copies of this patent or patent application publication with color drawing(s) will be provided by the Office upon request and payment of the necessary fee

A further understanding of the nature and advantages of the present invention may be realized by reference to the remaining portions of the specification and the drawings wherein like reference numerals are used throughout the several drawings to refer to similar components. In some instances, a sublabel is associated with a reference numeral and follows a hyphen to denote one of multiple similar components. When reference is made to a reference numeral without specification to an existing sublabel, it is intended to refer to all such multiple similar components.

FIG. 1 shows a simplified schematic for making micellar casein from milk.

FIG. 2 shows a simplified schematic for making casein salts from casein.

FIG. 3 shows a simplified schematic for making a nutritional composition.

FIG. 4A shows a schematic for a nutritional composition.

FIG. 4B shows a simplified schematic for a system to make a nutritional composition.

FIGS. 5A & 5B show pictures of the stability of a group of beverage creamers in hot brewed coffee and hot instant coffee, respectively, over a period of 8 weeks.

FIGS. 6A & 6B show graphs of the whitening power of a group of beverage creamers in hot brewed coffee and hot instant coffee, respectively, over a period of 8 weeks.

FIG. 7 shows a bar graph of the pH levels of a group of beverage creamers over a period of 8 weeks.

FIG. 8 shows a bar graph of the viscosity levels of a group of beverage creamers over a period of 8 weeks.

FIGS. 9A & 9B show bar graphs of the levels of particles of particular sizes (D(9) and D(4,3), respectively) in a group of beverage creamers over a period of 8 weeks.

FIG. 10 shows a graph of the whitening power of a group of beverage creamers in hot brewed coffee over a period of 9 weeks.

FIG. 11 shows a bar graph of the pH levels of a group of beverage creamers over a period of 9 weeks.

FIG. 12 shows a bar graph of the viscosity levels of a group of beverage creamers over a period of 9 weeks.

FIG. 13 shows a bar graph of the levels of particles of particular sizes (D(9)) in a group of beverage creamers at Day 0 and 8 weeks.

FIG. 14 shows a bar graph of the levels of particles of particular sizes (D(4,3)) in a group of beverage creamers at Day 0 and 8 weeks.

### DETAILED DESCRIPTION

Micellar caseins are described that can be used in a variety of nutritional compositions, including beverage creamers such as coffee creamers (e.g., hot coffee creamers, iced coffee creamers, etc.) and tea creamers (e.g., hot tea creamers, iced tea creamers, etc.). The present micellar caseins are a highly purified milk protein (e.g., greater than 80 wt. % protein on a dry basis, with a casein-to-whey ratio of at least 85:15) filtered directly from milk. They have been found to be an effective natural substitute for casein salts and other emulsifiers in beverage creamers (e.g., coffee creamers).

### Exemplary Nutritional Compositions

The present nutritional compositions (e.g., beverage creamers) include native micellar casein acting as an emulsifier, a protein source, a whitener, and/or a flavoring agent, among other functions. The micellar casein may constitute about 1 wt. % to about 15 wt. % of the nutritional composition on a dry basis. Specific examples include micellar casein constituting about 1 wt. %, about 2 wt. %, about 3 wt. %, about 4 wt. %, about 5 wt. %, about 6 wt. %, and about 7 wt. % about 8 wt. %, about 9 wt. %, about 10 wt. %, about 11 wt. %, about 12 wt. %, about 13 wt. %, about 14 wt. %, about 15 wt. %, of the nutritional composition on a dry basis, among other exemplary concentrations.

The present micellar casein is derived from cow's milk, such as whole milk (e.g., milk with about 3.5% milkfat), reduced-fat milk (e.g. milk with about 2% milkfat), low-fat milk (e.g., milk with about 1% milkfat), and fat-free milk (e.g., milk with about 0.8 wt. % or less milkfat). The micellar casein is separated from the other components of the milk to produce a micellar casein that is purified to a range of about 80 wt. % to 99 wt. % on a dry basis. For example, the micellar casein may be purified to about 80 wt. %, about 83 wt. %, about 86 wt. %, about 89 wt. %, about 91 wt. %, about 92 wt. %, about 93 wt. %, and about 99 wt. % on a dry basis, among other exemplary concentrations.

The micellar casein may replace some or all of other casein derived ingredients from the nutritional composition. For example, the micellar casein may replace about 10 wt. %, 20 wt. %, 30 wt. %, 40 wt. %, 50 wt. %, 60 wt. %, 70 wt. %, 80 wt. %, 90 wt. % or 100 wt. % of a casein salt (e.g., calcium caseinate, sodium caseinate, etc.) in the nutritional composition. They may also replace “reformed” casein micelles that have been synthesized from acid casein or casein salts. Reformed casein micelles start with acid casein or casein salts (also referred to as “processed casein”) that have been chemically treated with a series of inorganic salt solutions and filtration processes that reform the caseinate into a casein micelle. Like many complex proteins that have been denatured, the reformed casein micelle has significant structural and chemical differences from native micellar casein.

When the micellar casein replaces all the casein salts (i.e., replace 100% of the casein salts) it may be said that the casein compounds in the nutritional composition consist essentially of micellar casein and contains substantially no casein salts including sodium caseinate and calcium caseinate. However, the nutritional composition may contain other ingredients that act as emulsifiers, whiteners, protein sources, flavoring agents, and stabilization agents, among other functions.

In many instances, less micellar casein is needed than casein salt to create a stable nutritional composition. For example, only about 95 wt. %, about 90 wt. %, about 85 wt. %, about 80 wt. %, about 75 wt. %, about 70 wt. %, about 65 wt. %, about 60 wt. %, about 55 wt. %, about 50 wt. %, etc., of micellar casein is needed to provide an equivalent degree of stability to the nutritional composition as 100 wt. % of a casein salt. In other examples where increased amounts of proteins in the nutritional composition are desired, the micellar casein may replace the casein salts in a 1:1 weight ratio, or even greater than a 1:1 weight ratio of micellar casein to casein salts.

The reduction in the amount of micellar casein needed to replace casein salts and other protein-containing ingredients permits adjustment both up and down of the total amount of protein in the nutritional composition. For example, replacing casein salts with less micellar casein may result in a lower total weight percentage of protein in the nutritional composition. Alternatively, replacing the casein salts with more micellar casein may result in a higher total weight percentage of protein in the nutritional composition.

The nutritional composition may include a fat or oil to give the composition a creamy mouthfeel and create finely emulsified particles in an aqueous mixture that scatter light to create a milky white color. Exemplary oils include vegetable oils such as soybean oil, cottonseed oil, palm oil, palm kernel oil, coconut oil, corn oil, olive oil, peanut oil, sesame oil, sunflower oil, safflower oil, and/or a rapeseed oil (e.g., canola oil), and combinations thereof, among other types of vegetable oils. The vegetable oils may be unhydrogenated, partially hydrogenated, or fully hydrogenated. Specific examples of oil used in the nutritional composition may include partially hydrogenated coconut oil, unhydrogenated palm kernel oil, and/or fully hydrogenated soybean oil. In some instances, nutritional composition may include an animal fat, such as a dairy fat. Exemplary sources of dairy fat may include the milk from which the micellar casein is derived. The fat or oil may constitute about 10 wt. % to about 50 wt. % of the nutritional composition on a dry basis. Specific examples of the fat or oil concentrations may include about 10 wt. %, about 20 wt. %, about 30 wt. %, about 40 wt. %, and about 50 wt. % of the nutritional composition on a dry basis, among other exemplary concentrations.

The nutritional composition may include a sweetener that increases the sweetness of the composition. Exemplary sweeteners include a carbohydrate. For example the nutritional composition may include one or more of sucrose, fructose, high fructose corn syrup, corn syrup solids, dextrose, maltodextrin, brown sugar, agave nectar, honey, fruit juice concentrate, molasses, and maple syrup. Exemplary sweeteners used in the nutritional composition may also include one or more sugar alcohols, such as arabitol, erythritol, maltitol, mannitol, lactitol, sorbitol, isomalt, and xylitol. Exemplary sweeteners used in the nutritional composition may further include non-nutritive sweeteners, such as one or more of aspartame, acesulfame potassium, neotame, saccharin, sucralose, advantame, stevia, monk fruit extract, tagatose, and trehalose. In some instances, the nutritional composition may include lactose. Among other sources, the lactose may be supplied in dairy-sourced ingredients added to the nutritional composition. The sweetener may constitute about 25 wt. % to about 70 wt. % of the nutritional composition on a dry basis. Specific examples of the sweetener concentrations include about 25 wt. %, about 30 wt. %, about 35 wt. %, about 40 wt. %, about 45 wt. %, about 50 wt. %, about 55 wt. %, about 60 wt. %, about 65 wt. %, and about 70 wt. % of the nutritional composition on a dry basis, among other exemplary concentrations.

The nutritional composition may include an acidity regulator that maintains the pH of the composition during storage and/or when introduced to a beverage such as coffee. Exemplary acidity regulators include phosphate salts. Examples of the phosphate salts include dipotassium phosphate, sodium phosphates, and hexametaphosphates, among other phosphate salts. When acidity regulators are used in a nutritional composition, they may constitute about 0.5 wt. % to about 5 wt. % of the composition on a dry basis. Specific examples of acidity regulator concentrations may include about 0.5 wt. %, about 1 wt. %, about 2 wt. %, about 3 wt. %, about 4 wt. %, and about 5 wt. % of the nutritional composition on a dry basis, among other exemplary concentrations.

The nutritional composition may include one or more of a stabilization agent, also referred to as a stabilizer, that maintains a degree of homogeneity in the composition and/or beverage to which the composition is added. In many instances, the stabilization agent acts as an emulsifier that complements the micellar casein. When they help stabilize the finely emulsified fat and/or oil globules that scatter light in the nutritional composition, they also function as a whitener. Examples of stabilization agents include one or more of monoglycerides (e.g., distilled monoglycerides), diglycerides, and combinations thereof (e.g., a mono- and diglyceride combination with about 40% to about 50% monoglycerides). Examples of stabilization agents also include polysorbates (e.g., polysorbate 60), and sodium stearoyl lactylate. Further examples of stabilization agents include soy proteins (e.g., soy protein concentrates, soy protein isolates, etc.). Still further examples of stabilization agents include carrageenan, cellulose gum, guar gum, and cellulose gel, among other types of gums and gels. When a stabilization agent is used in the nutritional composition, it may constitute about 0.01 wt. % to about 3 wt. % of the composition on a dry basis. Specific examples of stabilization agent concentrations may include about 0.01 wt. %, about 0.05 wt. %, about 0.1 wt. %, about 0.5 wt. %, about 1 wt. %, about 1.5 wt. %, about 2 wt. %, about 2.5 wt. %, and about 3 wt. % of the nutritional composition on a dry basis, among other exemplary concentrations.

The nutritional composition may include an anti-caking agent that prevents powdered compositions (e.g., powdered beverage creamers) from clumping and caking before being added to a beverage. Examples of anti-caking agents include sodium aluminosilicate. When an anti-caking agent is used in the nutritional composition, it may constitute about 0.001 wt. % to about 1 wt. % of the composition on a dry basis. Specific examples of anti-caking agent concentrations may include about 0.001 wt. %, about 0.005 wt. %, about 0.01 wt. %, about 0.05 wt. %, about 0.1 wt. %, about 0.2 wt. %, about 0.3 wt. %, about 0.4 wt. %, about 0.5 wt. %, about 0.6 wt. %, about 0.7 wt. %, about 0.8 wt. %, about 0.9 wt. %, and about 1 wt. % of the nutritional composition on a dry basis, among other exemplary concentrations.

The nutritional composition may include a colorant that give the composition a more cream-like appearance. Specific examples of colorants include annatto and titanium dioxide, among others. When a colorant is used in the nutritional composition, it may constitute about 0.1 wt. % to about 1 wt. % of the nutritional composition on a dry basis. Specific examples of colorant concentrations may include about 0.1 wt. %, about 0.2 wt. %, about 0.3 wt. %, about 0.4 wt. %, about 0.5 wt. %, about 0.6 wt. %, about 0.7 wt. %, about 0.8 wt. %, about 0.9 wt. %, and about 1 wt. % of the nutritional composition on a dry basis, among other exemplary concentrations.

The nutritional composition may include an instantizer that accelerates the dissolution of powdered compositions (e.g., powdered beverage creamer) in a aqueous beverage. Examples of instantizers include lecithin. When an instantizer is used in the nutritional composition, it may constitute about 0.1 wt. % to about 1 wt. % of the composition on a dry basis. Specific examples of instantizer concentrations may include about 0.1 wt. %, about 0.2 wt. %, about 0.3 wt. %, about 0.4 wt. %, about 0.5 wt. %, about 0.6 wt. %, about 0.7 wt. %, about 0.8 wt. %, about 0.9 wt. %, and about 1 wt. % of the nutritional composition on a dry basis, among other exemplary concentrations.

The nutritional composition may include one or more flavoring ingredients that add specific flavors or combinations of flavors, and aromas to the composition. When an flavoring ingredient is used in the nutritional composition, it may constitute about 0.1 wt. % to about 1 wt. % of the composition on a dry basis. Specific examples of flavoring ingredient concentrations may include about 0.1 wt. %, about 0.2 wt. %, about 0.3 wt. %, about 0.4 wt. %, about 0.5 wt. %, about 0.6 wt. %, about 0.7 wt. %, about 0.8 wt. %, about 0.9 wt. %, and about 1 wt. % of the nutritional composition on a dry basis, among other exemplary concentrations.

The nutritional composition may include one or more viscosity agents that adjust the viscosity of the nutritional composition and/or ingredients that make up the nutritional composition. Exemplary viscosity agents include a sulfated polysaccharide, such as a carrageenan. When a viscosity agent is used in the nutritional composition, it may constitute about 0.01 wt. % to about 1 wt. % of the composition on a dry basis. Specific examples of viscosity agent concentrations may include about 0.01 wt. %, about 0.05 wt. %, about 0.1 wt. %, about 0.2 wt. %, about 0.3 wt. %, about 0.4 wt. %, about 0.5 wt. %, about 0.6 wt. %, about 0.7 wt. %, about 0.8 wt. %, about 0.9 wt. %, and about 1 wt. % of the nutritional composition on a dry basis, among other exemplary concentrations.

### Exemplary Methods of Making Micellar Casein

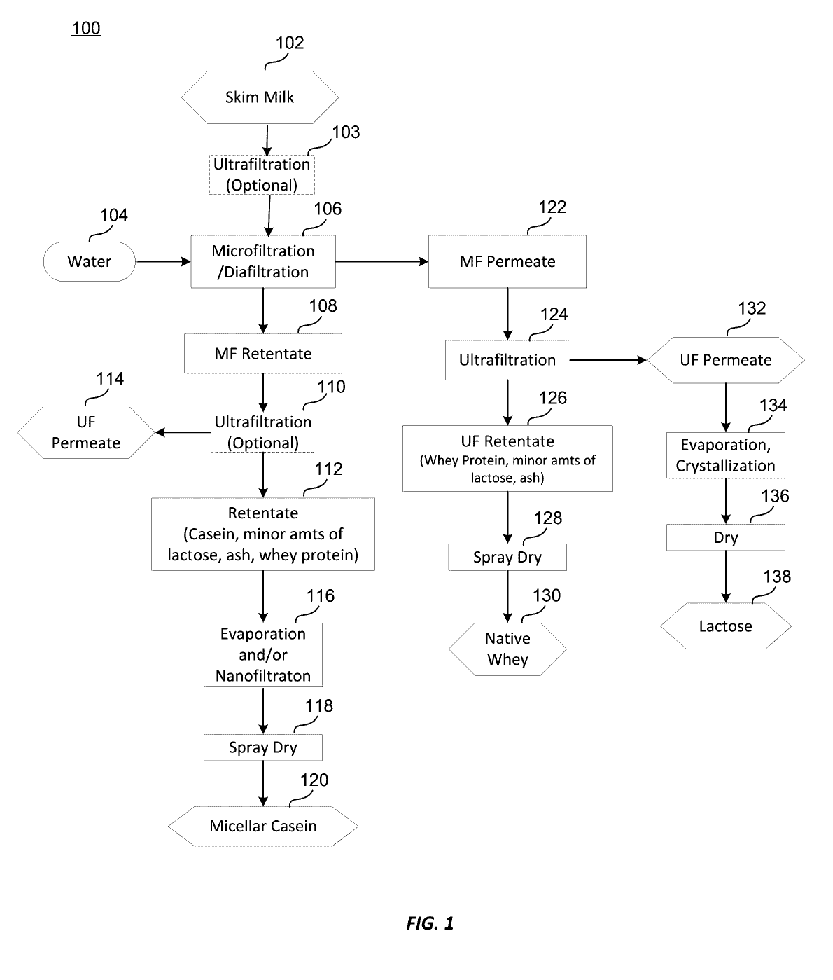

The present nutritional compositions include micellar casein as a complement, substitute, or reduction of some or all of the casein salts used in conventional nutritional compositions like beverage creamers (e.g., coffee creamers). FIG. 1 shows a simplified flowchart of a method 100 of making micellar casein from skim milk 102. It should be appreciated that while FIG. 1 shows skim milk 102 as the starting milk, alternate embodiments using other types of milk such as whole milk, reduced-fat milk, and low-fat milk, among other types of milk may replace the skim milk 102 shown in FIG. 1.

The skim milk 102 undergoes a microfiltration/diafiltration step 106 that separates the skim milk 102 into retentate and permeate fractions. In some embodiments, the skim milk 102 may also undergo an ultrafiltration step 103 in addition to the microfiltration/diafiltration step 106. In alternate methods (not shown) the skim milk may undergo only a microfiltration step, diafiltration step, or ultrafiltration step. In further alternate methods, the skim milk may undergo a ultrafiltration/microfiltration sequence of steps, or a ultrafiltration/microfiltration/ultrafiltration sequence of steps.

The retentate fraction 108 that includes a majority of the micellar casein, along with any residual milkfats, as well as some lactose, minerals and whey protein that do not get swept up into the permeate fraction 122. The permeate fraction 122 includes a majority of the whey protein, lactose, minerals, and some casein protein. The lactose, minerals (e.g., calcium), whey protein, and other milk components that are filtered into the permeate fraction 122 may undergo further processing. Additional non-casein ingredients may be washed into the permeate 122 via diafiltration. A source of water 104 may be supplied to the diafiltration unit for this purpose.

The microfiltered milk protein retentate that include the micellar casein in the retentate fraction 108 may be purified to a range of about 80 wt. % to 99 wt. % on a dry basis. For example, the micellar casein may be purified to about 80 wt. %, about 82 wt. %, about 84 wt. %, about 86 wt. %, about 88 wt. %, about 90 wt. %, about 92 wt. %, about 94 wt. %, about 96 wt. %, about 98 wt. %, and about 99 wt. % on a dry basis, among other exemplary concentrations. The milk ingredients remaining in the micellar casein may include minor amounts of lactose, whey, and minerals.

At this stage, the micellar casein purified from the retentate fraction 108 also includes residual water from the skim milk 102 and the diafiltration water 104. This may be further removed from the micellar casein by, for example, an ultrafiltration step 110 that further separates the retentate fraction 108 into a ultrafiltration permeate fraction 114 and ultrafiltration retentate fraction 112. In some embodiments, the ultrafiltration step 110 may not be performed (i.e., optional). The UF retentate fraction 112 may then undergo additional purification steps such as nanofiltration and/or evaporation 116, followed by a spray drying step 118 that leaves a dry powder micellar casein 120. The dry powder micellar casein 120 is a native micellar casein whose native protein structure found in the skim milk 102 has not been significantly altered by exposure to excessive heat, acid or alkaline compounds, or other denaturing conditions.

As noted above, the microfiltration/diafiltration step 106 also produces a permeate fraction 122 that includes most of the whey proteins, minerals, lactose, and other components of the starting skim milk 102 that did not get caught in the retentate fraction 108, including some casein proteins. In method 100, the permeate fraction 122 undergoes an ultrafiltration step 124 that produces a second, ultrafiltered permeate 132 and a retentate that includes primarily native whey protein retentate fraction 126 (i.e., serum proteins) with minor amounts of lactose, minerals, and casein proteins that were not permeated in the ultrafiltered permeate 132. Similar to the micellar casein, the wet whey protein retentate fraction 126 may be spray dried 128 to produce a dry powdered native whey protein 130. The dry powdered native whey protein retains a protein structure substantially the same as found in the starting skim milk 102, and has not been significantly denatured by exposure to heat or other denaturing conditions. The dry powdered native whey protein 130 may be used in a variety of foods and products as a protein fortification ingredient (e.g., infant formula). However, whey protein ingredients (e.g., whey protein concentrate, whey protein isolate, etc.) are normally not used in beverage creamers.

The ultrafiltered permeate 132 is primarily made of lactose sugar with a minor amount of minerals and milk proteins that were not captured in the earlier retentate fraction 108 or whey protein retentate fraction 126. The ultrafiltered permeate 132 may undergo an evaporation and concentration step 134 to crystallize the lactose and separation/drying of the crystallized lactose 136 to remove residual water and leave behind a dry powdered lactose 138. The lactose 138 may be used as an ingredient in a variety of different products, although generally used sparingly (if at all) in the present nutritional compositions.

### Exemplary Methods of Making Casein Salts

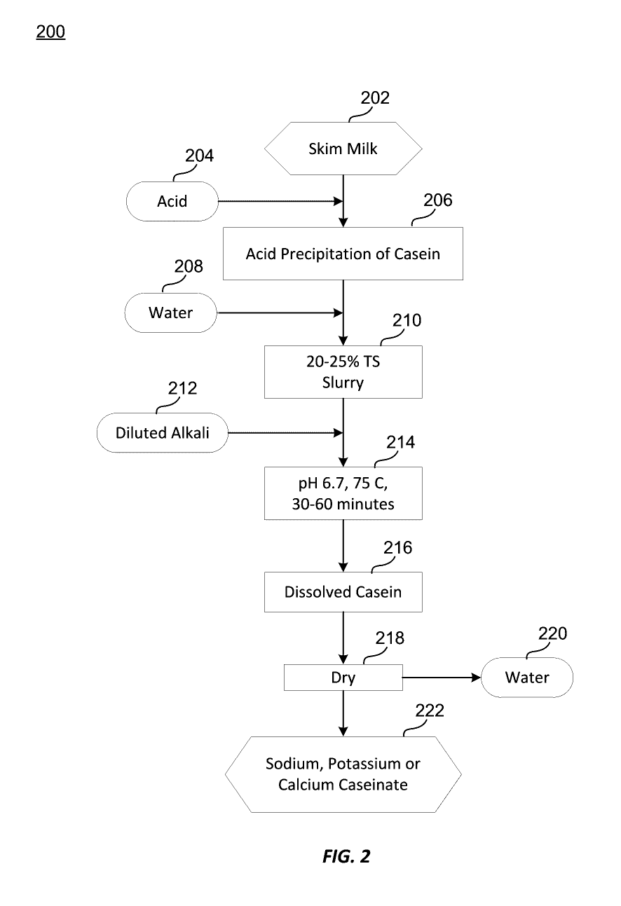

As noted above, the present micellar casein replaces some or all of the casein salts (e.g., sodium caseinate, calcium caseinate, potassium caseinate, etc.) used in nutritional compositions such as beverage creamers. FIG. 2 shows a simplified flowchart for a method of making casein salts and shows how these salts are derived from casein proteins. The method 200 shown in FIG. 2 starts with casein proteins from three sources: rennet casein 202, lactic acid casein 204, and mineral acid casein 206. In the embodiment described in method 200, these sources of casein protein are dry powders that may be combined with water 208 to form a slurry 210 having a total solids level of, for example, about 20 wt. % to about 25 wt. %.

An alkaline solution 212 may be added to the slurry 210 to raise the pH of the slurry to about 6.7, and in addition the temperature of the more alkaline slurry may be adjusted to about 60-75° C. The more alkaline, heated slurry 214 may be held under these conditions for 30-60 minutes as the casein proteins are converted into a dissolved casein salt solution 216. The casein salts are significantly more soluble in water than native casein proteins, and the alkaline, heated slurry 214 may be converted into the casein salt solution 216 over the 30-60 minute conversion period.

The casein salt solution 216 may be dried 218 to remove water 220 and leave behind dry powdered casein salts 222. The type of casein salt 222 produces depends on the alkaline solution 212 used to denature the casein proteins. For example, when the alkaline solution is an aqueous sodium hydroxide solution, the dominant casein salt 222 is sodium caseinate. Similarly, an aqueous calcium hydroxide solution produces calcium caseinate, and aqueous potassium hydroxide produces potassium caseinate. When a combination of two or more alkali metal cations (e.g., sodium ions, potassium ions) or alkali earth metal cations (e.g. calcium ions) are used in the alkaline solution 212, a blend of two or more casein salts 222 are formed.

In conventional liquid beverage creamers (e.g., coffee creamers) the powdered casein salts 222 may be partially or fully dissolved in the aqueous phase of the creamer and act as an emulsifier for the less polar liquid components of the creamer, such as a vegetable oil. In powdered beverage creamers, the casein salts 222 and other creamer ingredients may be first dissolved into a liquid mixture that undergoes subsequent water removal to make the powdered creamer.

As noted above, the conventional casein salts in the beverage creamer can be replaced with less micellar casein while achieving the same degree of emulsification. For example, the amount of micellar casein required to achieve the same degree of emulsification in the creamer and/or beverage may be about 1 wt. % to about 50 wt. % less than the requisite amount of casein salt. Specific reduction percentages include about 1 wt. % less, about 5 wt. % less, about 10 wt. % less, about 20 wt. % less, about 30 wt. % less, about 40 wt. % less, and about 50 wt. % less, among other reduction percentages.

### Exemplary Methods of Making Nutritional Compositions

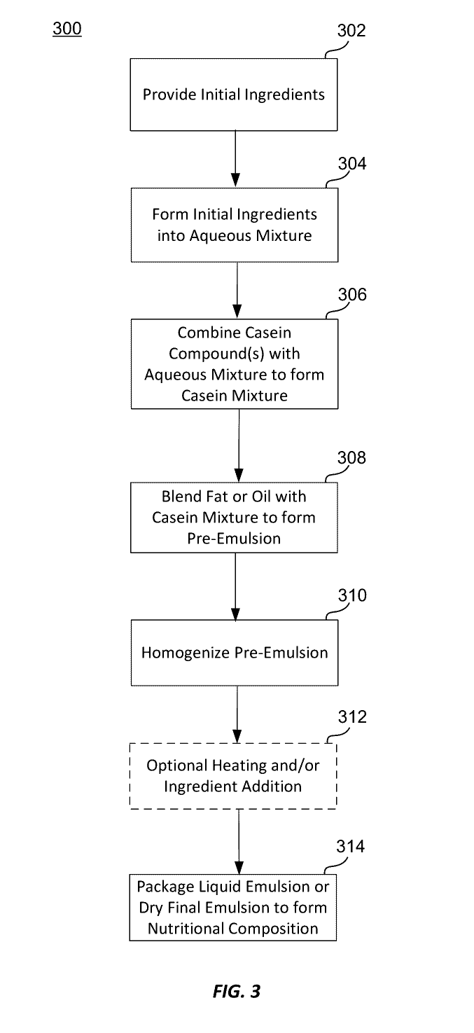

The native micellar caseins described above may be used in nutritional compositions that include beverage creamers (e.g., coffee creamers). FIG. 3 shows selected steps in a method 300 of making a nutritional composition. The method 300 includes providing initial ingredients 302 that will go into the nutritional composition. These initial ingredients may include one or more of a sweetener, an acidity regulator, a stabilization agent, an anti-caking agent, a colorant, an instantizer, a viscosity agent, and a flavor ingredient, among other ingredients. Exemplary combinations of initial ingredients (when more than one initial ingredient is provided) include (i) a sweetener; (ii) a sweetener and an anti-caking agent; (iii) a sweetener and an acidity regulator; (iv) a sweetener, an anti-caking agent, and an instantizer; (v) a sweetener, an acidity regulator, and an instantizer, (vi) a sweetener and a colorant; (vii) a sweetener and a flavor agent; and (viii) a sweetener and a stabilization agent, among other exemplary combinations.

The initial ingredients are combined with water to form an aqueous mixture 304. If all the initial ingredients are fully water soluble then the aqueous mixture is an aqueous solution. If one or more of the initial ingredients are only partially soluble in water, or water insoluble, then the aqueous mixture may be a dispersion, suspension, or slurry.

The aqueous mixture of the initial ingredients are combined with one or more casein compounds to form a casein mixture 306. If only a single casein compound is combined with the aqueous mixture, then the casein compound is micellar casein. If more than one casein compound is combined with the aqueous mixture, at least one of those casein compounds is micellar casein, and the other compounds may include casein salts, such as sodium caseinate, potassium caseinate, and/or calcium caseinate. The micellar casein will form a suspension with the aqueous phase of the casein mixture, while casein salts (if present) will normally dissolve into the aqueous phase, particularly sodium and potassium caseinate.

The casein mixture may be blended with a fat or oil to form a pre-emulsion 308. The blending of the caseinate mixture and the fat or oil may take place in a blender (e.g., a liquefier). Prior to blending, the casein mixture, fat or oil, or both may be heated and/or agitated to facilitate the blending of the two liquids. Exemplary fats and oils used in blending step 308 include vegetable oils such as soybean oil, cottonseed oil, palm oil, palm kernel oil, coconut oil, corn oil, olive oil, peanut oil, sesame oil, sunflower oil, safflower oil, a rapeseed oil (e.g., canola oil), as well as combinations of these vegetable oils.

In some instances, additional ingredients may be added to the casein mixture, fat or oil, or both, before or during blending step 308. These additional ingredients may include one or more of a sweetener, an acidity regulator, a stabilization agent, an anti-caking agent, a colorant, an instantizer, a viscosity agent, and a flavor ingredient, among other ingredients. Exemplary combinations of the additional ingredients (when more than one additional ingredient is added to the casein mixture) include (i) a stabilization agent and a viscosity agent; (ii) a stabilization agent and an instantizer; (iii) a viscosity agent and an instantizer; (iv) a stabilization agent and a colorant; (v) a viscosity agent and a colorant; (vi) a colorant and a flavor ingredient; and (vii) a viscosity agent, a colorant, and a flavor ingredient, among other ingredient combinations.

The pre-emulsion may be homogenized to form a final emulsion in step 310. The homogenization may occur in a single stage, or may be divided into two or more stages that are interrupted by a heating step, pasteurization step, and/or ingredient addition step 312, among other actions. The homogenization step 310 may be carried out using, for example, a two-stage homogenizer that disrupt the fat and/or oil into finely emulsified particles that are uniformly distributed in the aqueous phase of the final emulsion.

The final emulsion may be packaged as a liquid or dried to form a powdered nutritional composition at step 314. Examples of the nutritional composition may include beverage creamers (e.g., coffee creamers) where some or all of the casein salts in the powdered creamer are replaced with micellar casein. The powdered nutritional composition may be packaged in larger-sized containers and/or individual serving packets for storage prior to use.

It should be appreciated that the methods of making the present nutritional compositions are not limited to powdered compositions. For example, the final liquid emulsion formed by homogenization step 310 may be cooled and packaged into a liquid nutritional composition (e.g., liquid coffee creamer). Additional examples of making a liquid nutritional composition are described below.

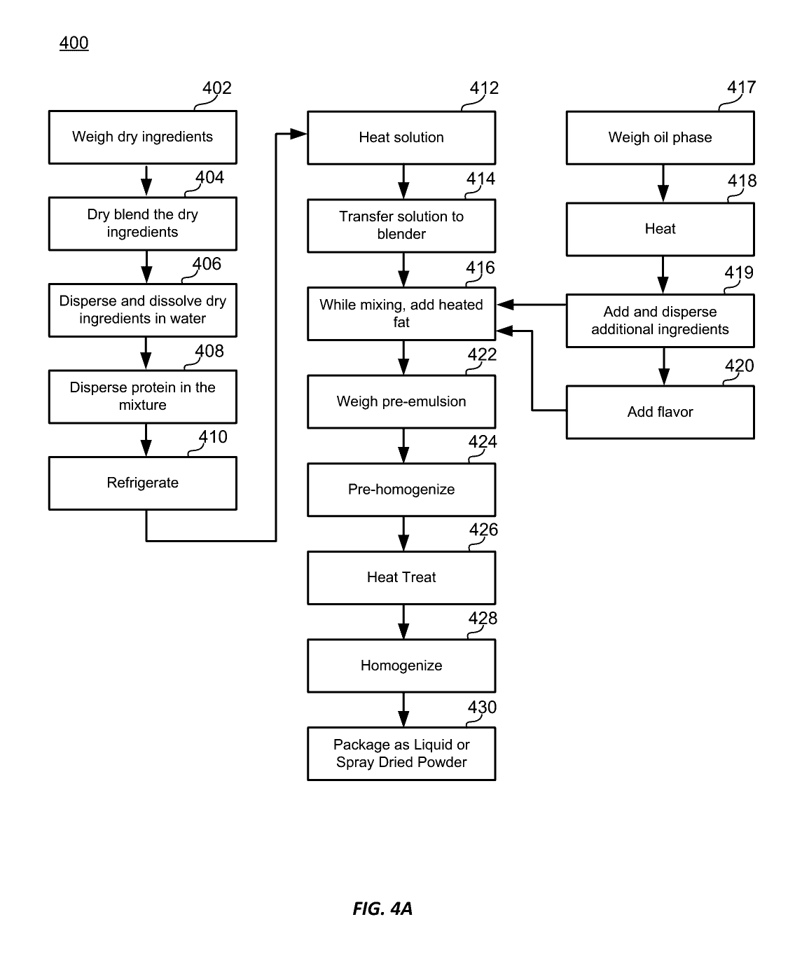

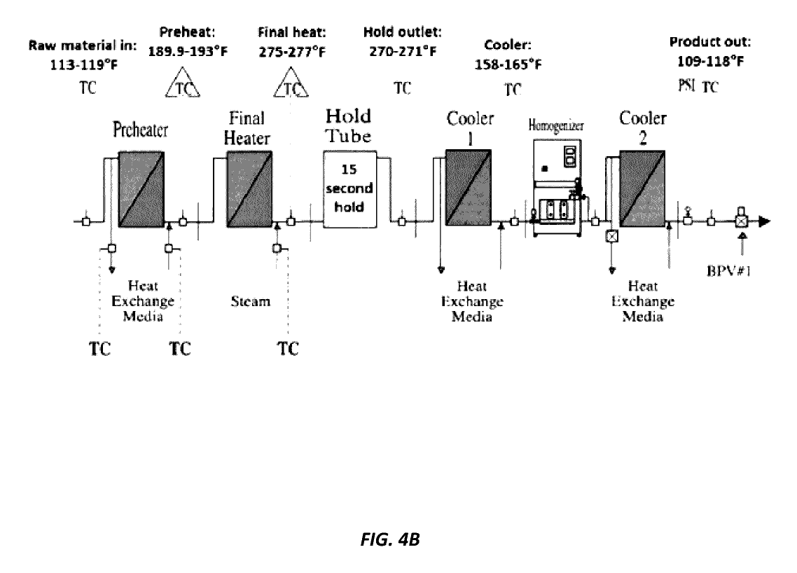

Referring now to FIG. 4, selected steps in another method 400 of making a nutritional composition are described. The method 400 includes weighing dry ingredients 402 used to make the nutritional composition. These ingredients may include a sweetener (e.g., corn syrup solids), an acidity regulator (e.g., dipotassium phosphate), and an anti-caking agent (e.g., sodium aluminosilicate), among other ingredients. The weighed, dry ingredients may then be blended together in step 404 before being dispersed and dissolved in water in step 406.

Following the dispersion and dissolving of the dry ingredients, at least one casein compound is dispersed into the aqueous mixture in step 408. If only one casein compound is used, the compound is micellar casein. If a combination of more than one casein compound is used, the combination may include micellar casein and one or more casein salts, such as sodium caseinate, potassium caseinate, and/or calcium caseinate. Exemplary weight ratios of micellar casein to casein salts in the combination of casein compounds include about 9:1, about 8:1, about 7:1, about 6:1, about 5:1, about 4:1, about 3:1, about 2:1, about 1:1, about 1:2, about 1:3, about 1:4, about 1:5, about 1:6, and about 1:7 among other weight ratios of micellar casein to casein salts.

The aqueous mixture of ingredients, including the at least one casein compound, may be refrigerated 410 for a period ranging from greater than or equal to about 4 hours to about 12 hours (e.g., overnight). The refrigeration temperature may range from about 0° C. to about 10° C., about 0° C. to about 5° C., etc. The refrigeration temperature may have a lower temperature threshold above the freezing point of the aqueous mixture.

Following the refrigeration period, the aqueous mixture of ingredients may be heated and agitated in step 412. The heating temperature may range from about 60° C. to about 75° C. (e.g., about 65-70° C.). The heated mixture may be transferred to a blender (e.g., a high-shear liquefier) in step 414. While the aqueous mixture is being blended, an ingredient composition including a fat and/or oil is combined with the aqueous mixture in the blender at step 416. The ingredient composition may be prepared by measuring (e.g., weighing) the fat and/or oil (e.g., a vegetable oil) in step 417, and then heating the fat and/or oil in step 418. The heating may be done by, for example, a microwave oven that heats the fat and/or oil to a temperature ranging from about 60° C. to about 75° C. (e.g. 65-70° C.). The heated fat and/or oil has a fluid consistency, into which additional ingredients (e.g., carrageenan) may be added in step 419. The mixture of heated fat and/or oil, plus additional ingredients (if any are added) is then combined with the aqueous mixture in step 416.

One or more flavoring ingredients may also be added to the blending mixture in step 420. The flavoring ingredients may be added to the blending mixture as a dry powder, liquid, or dispersion (e.g., aqueous dispersion) depending on the type of flavoring ingredients used. The flavoring ingredients may be added to the aqueous mixture in the blender prior to the addition of the heated fat and/or oil. Alternatively, the flavoring ingredients may be added simultaneously with or after the heated fat and/or oil is combined with the aqueous mixture.

Following the combination of the heated fat and/or oil with the aqueous mixture and flavoring ingredients (if used), the mixture is blended in the blender for a period of time to form a pre-emulsion. Exemplary blending times may range from about 1 minute to about 10 minutes (e.g., about 2 minutes). The pre-emulsion may then be weighed in step 422 before being transferred to a first homogenization stage (i.e., pre-homogenization) in step 424. Exemplary first homogenization stages may include passing the pre-emulsion through a two-stage homogenizer set at 2500/500 psi to form an initial emulsion. The temperature of the pre-emulsion passing through the first homogenization stage 424 may range from about 65° C. to about 75° C. (e.g., about 70° C.).

The initial emulsion may then be heat treated (e.g., pasteurized) in step 426. Following heat treatment step 426, the initial emulsion may undergo a second homogenization stage in step 428. Exemplary methods of heat treatment 426 in the initial emulsion include, for example, running the initial emulsion through a high-temperature short-time (HTST) heat exchanger, or an ultra-high temperature (UHT) heat exchanger. The temperature of the pre-homogenized solution entering that is heat treated 426 may be about 45° C. to about 50° C. The heat treatment step 426 preheats the solution to about 87° C. to about 90° C., before a final heat treatment at about 135° C. to about 137° C. After the final heat treatment, the solution may be held for about 3 seconds to about 30 seconds and then cooled before undergoing the second homogenization step 428 that completes the homogenization of the solution.

The second homogenization step 428 may include passing the pasteurized initial emulsion through a two-stage homogenizer set at 4000/500 psi to form a final emulsion of the nutritional composition. As noted above, the temperature of the initial emulsion passing through the second homogenization step 428 may be cooled to, for example, about 65° C. to about 75° C. (e.g., about 70-74° C.). In some examples, the finally homogenized solution produced by the second homogenization step 428 may be further cooled to about 42° C. to about 48° C. before being packaged.

The final emulsion may be packaged as a liquid or spray dried powder and cooled in step 430. In the exemplary method 400, the final emulsion may be a liquid nutritional composition (e.g., liquid beverage creamer) that can be stored refrigerated until used in a beverage such as hot coffee, hot tea, iced-coffee, iced-tea, etc. In alternative methods, the initial emulsion may be high-temperature pasteurized to extend the shelf life of the packaged nutritional composition and permit storage at unrefrigerated temperatures (e.g., room temperature). In further alternative methods, the final emulsion may be dried to form a powdered nutritional composition instead of remaining a liquid composition.

### EXAMPLES

Nutritional compositions in the form of coffee creamers were evaluated for in-beverage stability (specifically stability in coffee), whitening ability, acidity stability, viscosity stability, and particle size for periods of 0 to 8 weeks. The analyzed coffee creamers included a control creamer made with no micellar casein (i.e., exclusively sodium caseinate), and a series of creamers that substituted the casein salts with reduced levels of micellar casein that also resulted in an overall reduction of protein levels in the creamers. Except for the control and the commercial coffee creamer, none of the analyzed creamers contained sodium caseinate. The analyzed coffee creamers are described in additional detail below.

### Sample Coffee Creamers Tested

Liquid coffee creamers were made according to method 400 described above with the casein compound being either sodium caseinate (the control), or native micellar casein at specific weight percentages of the sodium caseinate used in the control. For example, if the control creamer used 1 gram of protein from sodium caseinate, the 70% micellar casein creamer substituted 0.7 g of native micellar casein protein for the 1 g of sodium caseinate protein. Consequently, the coffee creamer made with the 70% miceller casein contained 30% less protein than the creamer used as the control. Similarly, the 100% micellar casein creamer substituted 1 g of native micellar casein protein for the 1 g of sodium caseinate protein. The micellar casein creamers tested include creamers where the micellar casein protein replaced the sodium caseinate protein at levels of 50 wt. %, 70 wt. %, 80 wt. %, 90 wt. %, and 100 wt. %. The control creamer made with sodium caseinate protein and the other creamers made with the micellar casein protein had the following formulations:

TABLE 1
Ingredients Used in Analyzed Coffee Creamers

| | Sodium Casein Control | | | 70% Micellar Casein | | |
|---|---|---|---|---|---|---|
| | “As Is” | Solids | % Protein | “As Is” | Solids | % Protein |
| | Basis | Basis | Used | Basis | Basis | Used |
| Water | 80.3979 | | | 80.5528 | | |
| Protein Source | 0.6410 | 3.2701 | 0.5844 | 0.4861 | 2.4996 | 0.4091 |
| Corn Syrup Solids | 11.5000 | 58.6672 | | 11.5000 | 59.1345 | 30% less |
| Soybean Oil | 6.9500 | 35.4554 | | 6.9500 | 35.7378 | protein as |
| Mono and Diglycerides | 0.0100 | 0.0510 | | 0.0100 | 0.0514 | compared |
| Dipotassium Phosphate | 0.4091 | 2.0870 | | 0.4091 | 2.1036 | to sodium |
| Flavoring | 0.0500 | 0.2551 | | 0.0500 | 0.2571 | caseinate |
| Carageenan | 0.0400 | 0.2041 | | 0.0400 | 0.2057 | control |
| Sodium Aluminosilicate | 0.0020 | 0.0102 | | 0.0020 | 0.0103 | |
| | 100.00 | 100.00 | | 100.00 | 100.00 | |
| % Protein in Protein Source | 91.17% | | | 84.15% | | |
| | 80% Micellar Casein | | | 90% Micellar Casein | | |
| | “As Is” | Solids | % Protein | “As Is” | Solids | % Protein |
| | Basis | Basis | Used | Basis | Basis | Used |
| Water | 80.4833 | | | 80.4139 | | |
| Protein Source | 0.5556 | 2.8468 | 0.4675 | 0.6250 | 3.1910 | 0.5259 |
| Corn Syrup Solids | 11.5000 | 58.9239 | 20% less | 11.5000 | 58.7151 | 10% less |
| Soybean Oil | 6.9500 | 35.6105 | protein as | 6.9500 | 35.4843 | protein as |
| Mono and Diglycerides | 0.0100 | 0.0512 | compared | 0.0100 | 0.0511 | compared |
| Dipotassium Phosphate | 0.4091 | 2.0962 | to sodium | 0.4091 | 2.0887 | to sodium |
| Flavoring | 0.0500 | 0.2562 | caseinate | 0.0500 | 0.2553 | caseinate |
| Carageenan | 0.0400 | 0.2050 | control | 0.0400 | 0.2042 | control |
| Sodium Aluminosilicate | 0.0020 | 0.0102 | | 0.0020 | 0.0102 | |
| | 100.00 | 100.00 | | 100.00 | 100.00 | |
| % Protein in Protein Source | 84.15% | | | 84.15% | | |
| | 100% Micellar Casein | | | 50% Micellar Casein | | |
| | “As Is” | Solids | % Protein | “As Is” | Solids | % Protein |
| | Basis | Basis | Used | Basis | Basis | Used |
| Water | 80.3444 | | | 80.6916 | | |
| Protein Source | 0.6945 | 3.5333 | 0.5844 | 0.3473 | 1.7987 | 0.2923 |
| Corn Syrup Solids | 11.5000 | 58.5075 | 0.00% less | 11.5000 | 59.5596 | 50% less |
| Soybean Oil | 6.9500 | 35.3589 | protein as | 6.9500 | 35.9947 | protein as |
| Mono and Diglycerides | 0.0100 | 0.0509 | compared | 0.0100 | 0.0518 | compared |
| Dipotassium Phosphate | 0.4091 | 2.0813 | to sodium | 0.4091 | 2.1188 | to sodium |
| Flavoring | 0.0500 | 0.2544 | caseinate | 0.0500 | 0.2590 | caseinate |
| Carageenan | 0.0400 | 0.2035 | control | 0.0400 | 0.2072 | control |
| Sodium Aluminosilicate | 0.0020 | 0.0102 | | 0.0020 | 0.0104 | |
| | 100.00 | 100.00 | | 100.00 | 100.00 | |

| | | |
|---|---|---|
| % Protein in Protein Source | 84.15% | 84.15% |

| | 1920% Micellar Casein | | |
|---|---|---|---|
| | “As Is” | Solids | % Protein |
| | Basis | Basis | Used |
| Water | 67.7110 | | |
| Protein Source | 13.3300 | 41.2834 | 11.2172 |
| Corn Syrup Solids | 11.5000 | 35.6158 | 1800% less |
| Soybean Oil | 6.9500 | 21.5244 | protein as |
| Mono and Diglycerides | 0.0100 | 0.0310 | compared |
| Dipotassium Phosphate | 0.4091 | 1.2670 | to sodium |
| Flavoring | 0.0500 | 0.1549 | caseinate |
| Carageenan | 0.0400 | 0.1239 | control |
| Sodium Aluminosilicate | 0.0020 | 0.0062 | |
| | 100.00 | 100.01 | |

| | |
|---|---|
| % Protein in Protein Source | 84.15% |

The control creamer and four creamers made with varying amounts of micellar casein described in Table 1 above were then tested for in-beverage stability, whitening ability, acidity stability, viscosity stability, and particle size. The typical testing period was 8 weeks, with testing normally done in 1 week increments. The first test analyzed the stability of the coffee creamer in hot brewed coffee and instant coffee over a period of 8 weeks

### Stability of Coffee Creamers in Coffee Samples

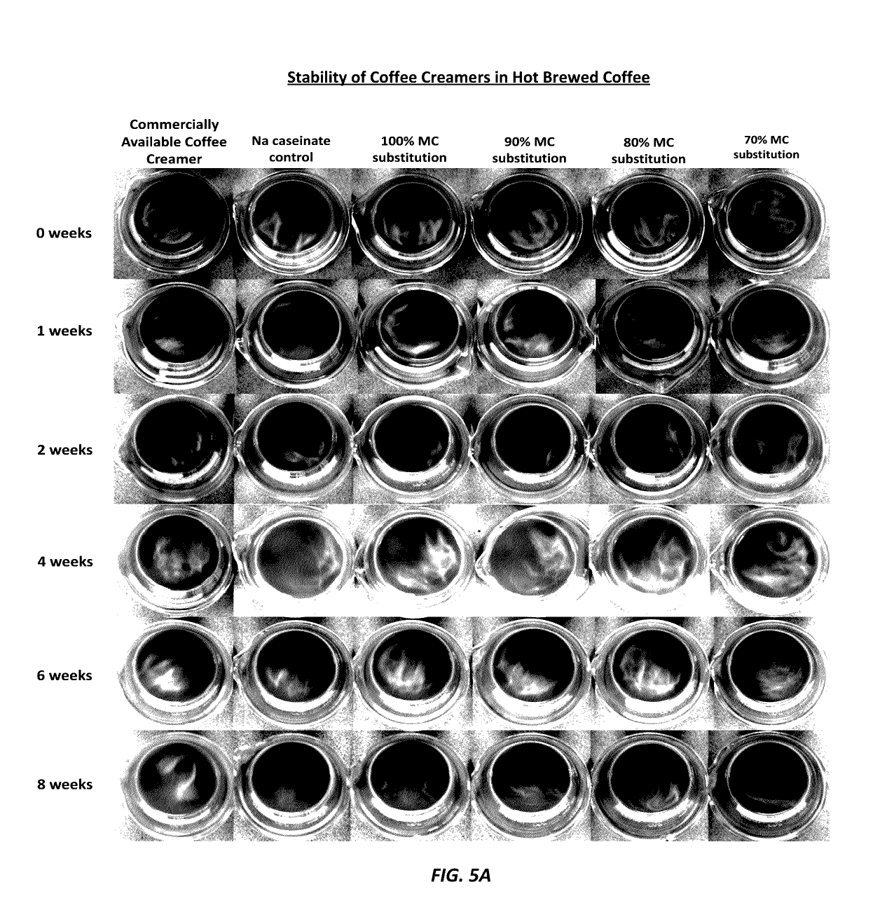

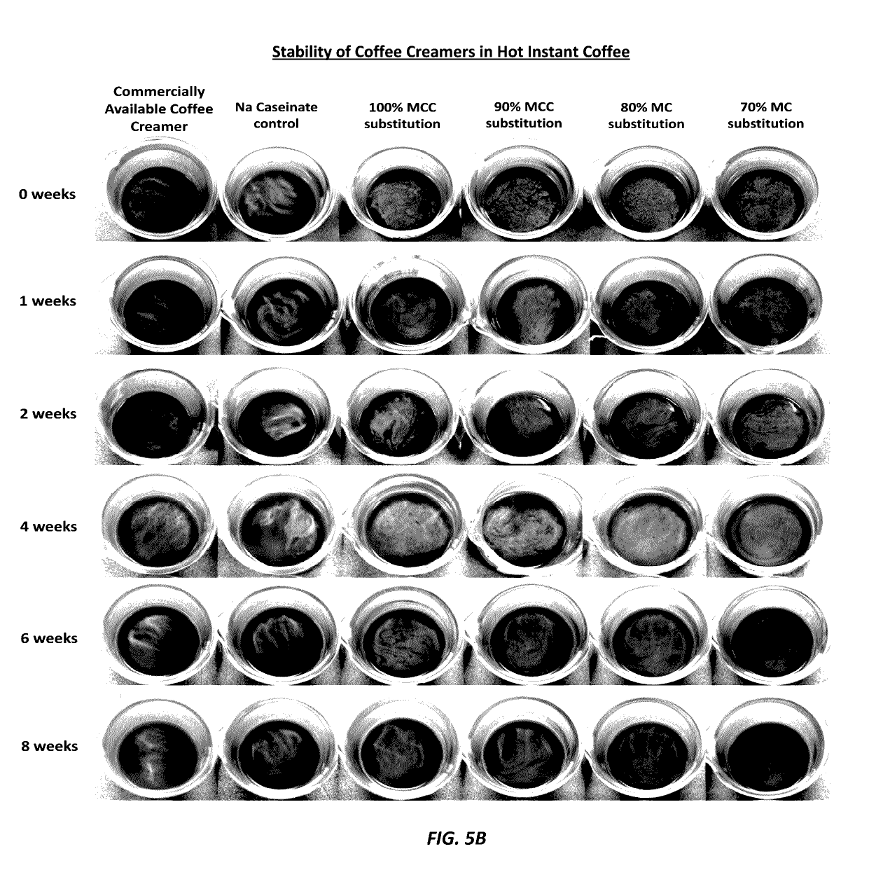

FIG. 5A pictorially records the stability of coffee creamers in hot brewed coffee over a period of 8 weeks. The coffee creamers tested included (i) a commercially available coffee creamer, (ii) a sodium caseinate control creamer, and (iii) the present creamers made with micellar casein in amounts ranging from 70%, 80%, 90% and 100% of the protein weight of sodium caseinate used in the control. The stability of the coffee creamers were recorded 5 minutes after the creamers were initially added and stirred into the hot brewed coffee. The stability analysis included looking for fish eyes (i.e., unemulsified fat droplets floating on the beverage surface), feathering (undissolved particles), and sediment. The creamers were evaluated again after 1 week, 2 weeks, 3 weeks, 4 weeks, 6 weeks, and 8 weeks. FIG. 5B pictorially records the stability of the same coffee creamers in hot instant coffee over the same 8 week period.

FIGS. 5A and 5B demonstrate that all the coffee creamers tested showed acceptable stability in both hot brewed coffee and hot instant coffee over the 8 week period measured. There was no noticeable feathering, oil drop formation, or protein instability in any of the tested samples. It is particularly notable that the 70% micellar casein coffee creamer made with 30 wt. % less protein than the sodium caseinate control had comparable stability in both hot coffees over the 8 week period.

### Whitening Ability of Coffee Creamers in Coffee Samples

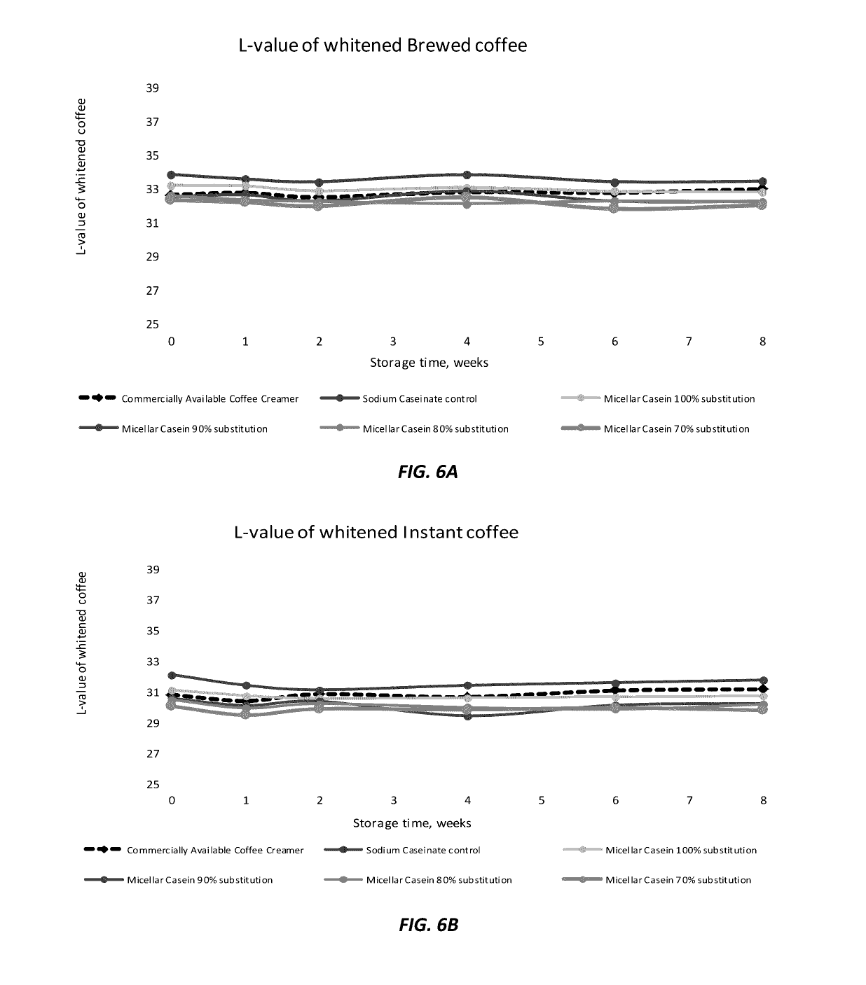

FIG. 6A is a graph measuring the whitening ability (i.e., L-value) of hot brewed coffee whitened with six different coffee creamers. The six creamers tested included (i) a commercially available coffee creamer, (ii) a sodium caseinate control creamer, and (iii) the present creamers made with micellar casein in amounts ranging from 70%, 80%, 90% and 100% of the protein weight of sodium caseinate used in the control. The whitening ability of the coffee creamers were recorded after the creamers were initially added and stirred into the hot brewed coffee. Creamers were evaluated at the initial production date (day 0) and again after 1 week, 2 weeks, 3 weeks, 4 weeks, 6 weeks, and 8 weeks. FIG. 6B is a graph measuring the whitening level (i.e., L-value) of the same six coffee creamers in instant coffee at the same intervals over the same 8 week period.

FIGS. 6A and 6B demonstrate that all the coffee creamers tested showed acceptable (i.e., statistically no different) whitening ability in both hot brewed coffee and hot instant coffee over the 8 week period measured. It is particularly notable that the 70% micellar casein coffee creamer made with 30 wt. % less protein than the sodium caseinate control had statistically similar whitening ability in both hot coffees over the 8 week period.

### Acidity Levels of Coffee Creamers Over Time

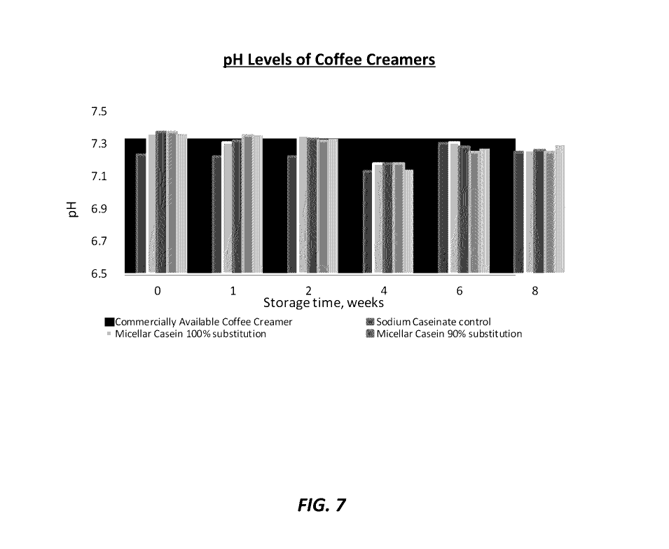

FIG. 7 is a graph measuring the pH of six different coffee creamers over a period of 8 weeks. The six creamers tested included (i) a commercially available coffee creamer, (ii) a sodium caseinate control creamer, and (iii) the present creamers made with micellar casein in amounts ranging from 70%, 80%, 90% and 100% of the protein weight of sodium caseinate used in the control. The pH of the coffee creamers were recorded at the time the creamers were produced (i.e., day 0), and again after 1 week, 2 weeks, 3 weeks, 4 weeks, 6 weeks, and 8 weeks. The graph shows all the coffee creamers had comparable pH stability over the 8 week period measured. The dip in pH at week 4 was attributed to a miscalibrated pH meter. The sodium caseinate control had a relatively flat pH range between 7.13 and 7.3. The micellar casein creamers showed a slight decrease in pH (increase in acidity) by approximately 0.1 over the 8 week period.

### Viscosity Levels of Coffee Creamers Over Time

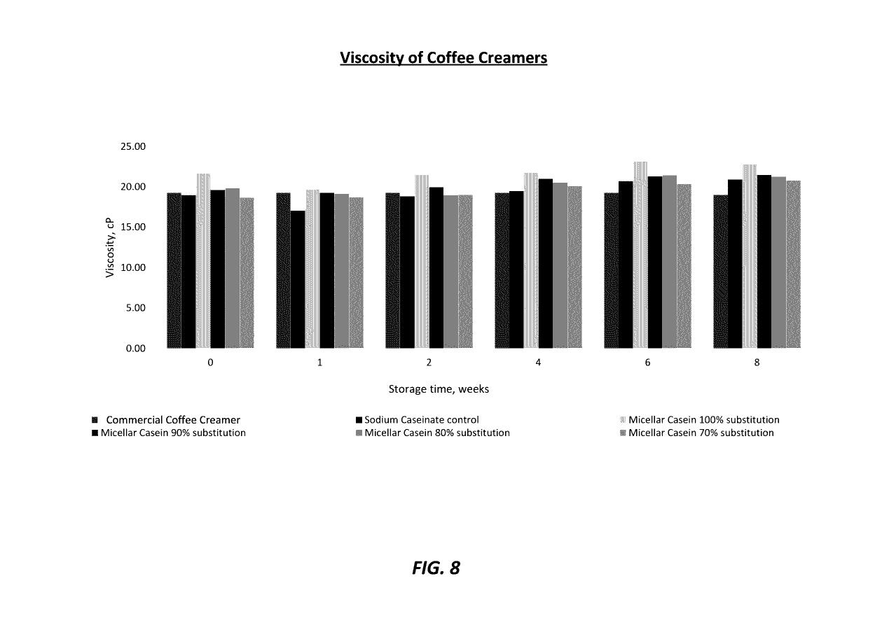

FIG. 8 is a graph measuring the viscosity of six different coffee creamers over a period of 8 weeks. The six creamers tested included (i) a commercially available coffee creamer, (ii) a sodium caseinate control creamer, and (iii) the present creamers made with micellar casein in amounts ranging from 70%, 80%, 90% and 100% of the protein weight of sodium caseinate used in the control. The viscosity of the coffee creamers were recorded at the time the creamers were produced (i.e., day 0), and again after 1 week, 2 weeks, 4 weeks, 6 weeks, and 8 weeks. The graph shows all the coffee creamers had comparable viscosity stability over the 8 week period measured, with increasing levels of micellar casein showing slightly higher viscosity levels. For example, the 100% micellar casein creamer consistently showed an average viscosity >20 cP for all periods measured. All the creamers also exhibited a gradually increasing viscosity (about 1-2 cP) over the period measured.

### Particle Size Measurements for Coffee Creamers Over Time

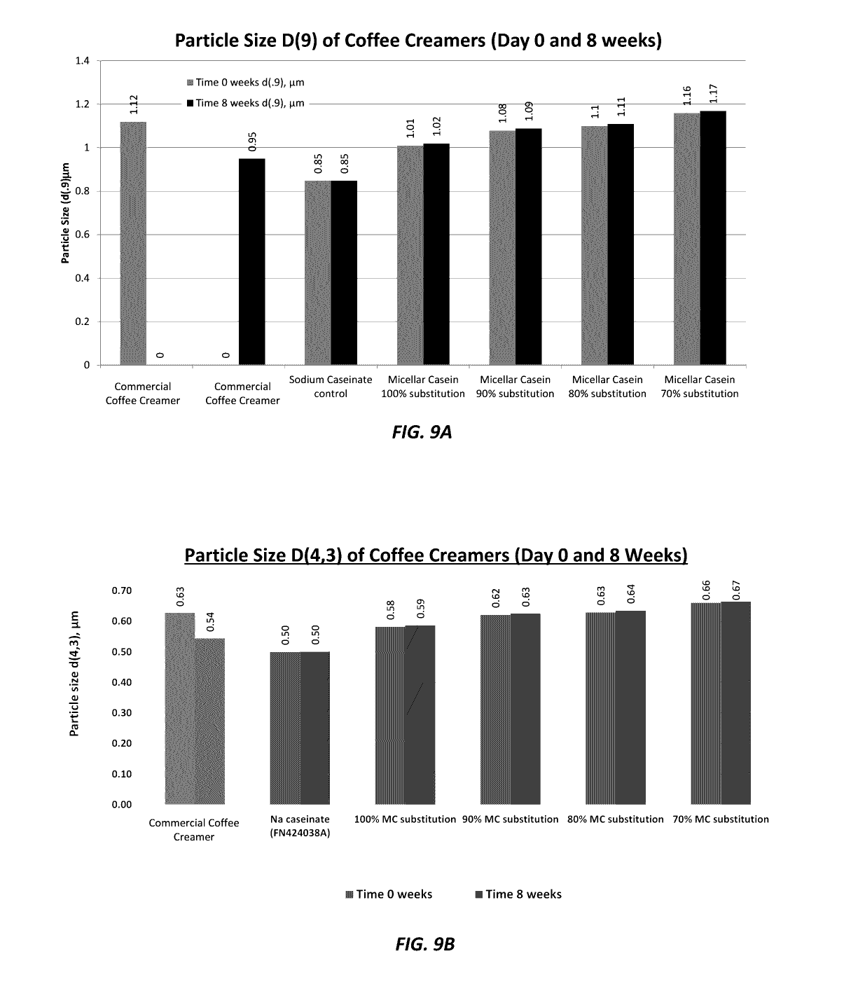

FIG. 9A is a graph measuring the value in which 90% of the particles in the creamers are smaller than approximately 9 μm for the six different coffee creamers analyzed. The particle measurements were taking upon the formation of the creamers and 8 weeks later. The six creamers tested included (i) a commercially available coffee creamer, (ii) a sodium caseinate control creamer, and (iii) the present creamers made with micellar casein in amounts ranging from 70%, 80%, 90% and 100% of the protein weight of sodium caseinate used in the control. FIG. 9B is a graph measuring the volume weighted mean of fat droplets in the same six coffee creamers, also at creation and 8 weeks later.

FIGS. 9A and 9B demonstrate that all the coffee creamers tested showed acceptable particle count size for both measurements over the 8 week period. This indicates that all six creamers form stable emulsions over this timeframe, and would have acceptable shelf-lives for liquid coffee creamers. The figures also show that as the total protein content of the creamer is decreased even by 30% when replace the sodium caseinate protein with a reduced weight of micellar casein protein, the particle size increases slightly. This may be explained by the fact that with less protein in the creamers to emulsify the fat particles, the average size of the particles is larger. Despite the larger average particle size, the reduced weight of micellar casein protein was still able to maintain stable emulsions over time.

### Coffee Creamer Flavor Analysis

Four coffee creamers were tested by trained tasting experts for flavor and aroma. The creamers tested included (i) a commercially available coffee creamer, (ii) a sodium caseinate control creamer, and (iii) the present creamers made with micellar casein in amounts of 80% and 100% of the protein weight of sodium caseinate used in the control. All creamers were tested after being aged for 12 days. Table 2 shows the aroma and flavor results:

TABLE 2
Coffee Creamer Aroma and Flavor Analysis

| | Commercially | | | |
|---|---|---|---|---|
| | Available | A (Na | | |
| | Coffee | Casein | B (100% | D (80% |
| Attribute | Creamer | Control) | MCC) | MCC) |
| Overall | 1.3b | 2.0a | 1.3b | 1.8ab |
| aroma | | | | |
| impact | | | | |
| Comments | Vegetable oil | sweet | Sweet and | Sweet and |
| (aroma) | | | oily | oily |
| Visual: | Opaque white | Creamy tan | Creamy tan | Creamy tan |
| Color | 0.0 | 1.4a | 1.0b | 1.3a |
| intensity | | | | |
| Aromatics: | | | | |
| Sweet | 0.5c | 1.3b | 1.5a | 1.2b |
| aromatic | | | | |
| Vegetable | 1.9a | 1.0b | 1.1b | 1.0b |
| oil | | | | |
| Cardboard | 1.3a | 1.3a | 1.1a | 1.1a |
| Sweet taste | 1.0a | 1.0a | 1.1a | 1.0a |
| Aftertaste | 1.2a | 0.9b | 0.8b | 0.9b |
| intensity | | | | |
| Aftertaste | Barny | clean | clean | clean |
| description | (tastes like | | | |
| | international | | | |
| | sourced dried | | | |
| | ingredients) | | | |

Aromatics were scored on a 0 to 15 point universal Spectrum intensity scale, visual and texture attributes were scored on a 0 to 15 point product specific scale. The letter following the value indicates differences (p<0.05). The results demonstrate that all the tested coffee creamers had acceptable aroma and flavor results. There were no negative aroma or flavors detected in the creamers using micellar casein as a replacement for conventional sodium caseinate.

The four coffee creamers were also added to coffee and the coffee was tested by trained tasting experts for flavor and aroma. Table 3 shows the aroma and flavor results:

TABLE 3
Aroma and Flavor Analysis of Coffee Mixed with Coffee Creamer

| | Commercially | | | |
|---|---|---|---|---|
| | Available | A (Na | | |
| | Coffee | Casein | B (100% | D (80% |
| Attribute | Creamer | Control) | MCC) | MCC) |
| Overall | 2.5c | 3.5b | 3.5b | 3.9a |
| aroma | | | | |
| impact | | | | |
| Comments | Slight sweet, | Sweet, nutty, | Sweet, nutty, | Sweet, nutty, |
| (aroma) | mostly | hazelnut, | hazelnut, | hazelnut, |
| | roasted | coconut with | coconut with | coconut with |
| | coffee | croasted | croasted | croasted |
| | | coffee | coffee | coffee |
| Visual: | Smooth, | Smooth, | Smooth, | Smooth, |
| | consistent | consistent | consistent | consistent |
| Color | 8.0a | 6.5b | 8.0a | 8.3a |
| intensity | | | | |
| Aromatics: | | | | |
| Sweet | 0.5b | 1.1a | 1.1a | 1.2a |
| aromatic | | | | |
| Vegetable | 1.5a | 1.0b | 1.0b | 1.1b |
| oil | | | | |
| Coffee | 3.3a | 3.4a | 3.2a | 3.6a |
| impact | | | | |
| Astringency | 3.5a | 3.6a | 3.5a | 3.7a |
| Bitter | 2.0a | 2.2a | 1.9a | 1.8a |
| taste | | | | |

Again, the aromatics were scored on a 0 to 15 point universal Spectrum intensity scale, visual and texture attributes were scored on a 0 to 15 point product specific scale. The letter following the value indicates differences (p<0.05). The results demonstrate that all the tested coffee creamers had acceptable aroma and flavor results. There were no negative aroma or flavors detected in the coffee using micellar casein coffee creamers as a replacement for conventional sodium caseinate.

### Additional Samples of Coffee Creamers Tested

Liquid coffee creamers were made according to method 400 described above with the casein compound being either sodium caseinate (the control), or native micellar casein at specific weight percentages of the sodium caseinate used in the control. For example, if the control creamer used 1 gram of protein from sodium caseinate, the 50% micellar casein creamer substituted 0.5 g of native micellar casein protein for the 1 g of sodium caseinate protein. Consequently, the coffee creamer made with the 50% miceller casein contained 50% less protein than the creamer used as the control. Similarly, the 1920% micellar casein creamer substituted 20.83 g of native micellar casein protein for the 1 g of sodium caseinate protein. Accordinly, the coffee creamer made with the 1920% miceller casein contained 1920% more protein than the creamer used as the control. In this example the micellar casein creamers tested include creamers where the micellar casein protein replaced the sodium caseinate protein at levels of 50 wt. %, and 1920 wt. %. The control creamer made with sodium caseinate protein and the other creamers made with the micellar casein protein had the following formulations:

TABLE 4
Ingredients Used in Analyzed Coffee Creamers

| | Sodium Casein Control | | | 50% Micellar Casein | | | 1920% Micellar Casein | | |
|---|---|---|---|---|---|---|---|---|---|
| | “As Is” | Solids | % Protein | “As Is” | Solids | % Protein | “As Is” | Solids | % Protein |
| | Basis | Basis | Used | Basis | Basis | Used | Basis | Basis | Used |
| Water | 80.3979 | | | 80.6916 | | | 67.7110 | | |
| Protein Source | 0.6410 | 3.2701 | 0.5844 | 0.3473 | 1.7987 | 0.2923 | 13.3300 | 41.2834 | 11.2172 |
| Corn Syrup Solids | 11.5000 | 58.6672 | | 11.5000 | 59.5596 | 50% less | 11.5000 | 35.6158 | 1800% |
| Soybean Oil | 6.9500 | 35.4554 | | 6.9500 | 35.9947 | protein as | 6.9500 | 21.5244 | more |
| Mono andDiglycerides | 0.0100 | 0.0510 | | 0.0100 | 0.0518 | compared | 0.0100 | 0.0310 | protein as |
| Dipotassium Phosphate | 0.4091 | 2.0870 | | 0.4091 | 2.1188 | to sodium | 0.4091 | 1.2670 | compared |
| Flavoring | 0.0500 | 0.2551 | | 0.0500 | 0.2590 | caseinate | 0.0500 | 0.1549 | to sodium |
| Carageenan | 0.0400 | 0.2041 | | 0.0400 | 0.2072 | control | 0.0400 | 0.1239 | caseinate |
| Sodium Aluminosilicate | 0.0020 | 0.0102 | | 0.0020 | 0.0104 | | 0.0020 | 0.0062 | |
| | 100.00 | 100.00 | | 100.00 | 100.00 | | 100.00 | 100.01 | |
| % Protein in Protein | 91.17% | | | 84.15% | | | 84.15% | | |
| Source | | | | | | | | | |

The control creamer and four creamers made with varying amounts of micellar casein described in Table 4 above were then tested for in-beverage stability, whitening ability, acidity stability, viscosity stability, and particle size. The typical testing period was 8 weeks, with testing normally done in 1 week increments. The first test analyzed the stability of the coffee creamer in hot brewed coffee and instant coffee over a period of 8 weeks

### Stability of Coffee Creamers in Coffee Samples

The stability of coffee creamers in hot brewed coffee was evaluated over a period of 8 weeks. The coffee creamers tested included (i) a sodium caseinate control creamer, and (ii) the present creamers made with micellar casein in amounts ranging from 50%, and 1920% of the protein weight of sodium caseinate used in the control. The stability of the coffee creamers were recorded 5 minutes after the creamers were initially added and stirred into the hot brewed coffee. The stability analysis included looking for fish eyes (i.e., unemulsified fat droplets floating on the beverage surface), feathering (undissolved particles), and sediment. The creamers were evaluated again after 1 week, 2 weeks, 3 weeks, 4 weeks, 6 weeks, and 8 weeks. Table 5 describes the results observed over the evaluation

TABLE 5
Evaluation of Fish Eyes for Coffee Creamers in hot Brewed Coffee

| | | Micellar casein | Micellar Casein |
|---|---|---|---|
| Storage Time, | Sodium | 50% | 1920% |
| weeks | Caseinate control | substitution | substitution |
| 0 | NO | NO | NO |
| 1 | NO | NO | NO |
| 2 | NO | NO | NO |
| 3 | NO | NO | NO |
| 4 | NO | NO | NO |
| 5 | NO | NO | NO |
| 6 | NO | NO | NO |
| 7 | NO | NO | NO |
| 8 | NO | NO | NO |

TABLE 6
Evaluation of Feathering for Coffee
Creamers in hot Brewed Coffee

| | | Micellar casein | Micellar Casein |
|---|---|---|---|
| Storage Time, | Sodium | 50% | 1920% |
| weeks | Caseinate control | substitution | substitution |
| 0 | NO | NO | NO |
| 1 | NO | NO | NO |
| 2 | NO | NO | NO |
| 3 | NO | NO | NO |
| 4 | NO | NO | NO |
| 5 | NO | NO | NO |
| 6 | NO | NO | NO |
| 7 | NO | NO | NO |
| 8 | NO | NO | NO |

TABLE 7
Evaluation of Sediment for Coffee Creamers in hot Brewed Coffee

| | | Micellar casein | Micellar Casein |
|---|---|---|---|
| Storage Time, | Sodium | 50% | 1920% |
| weeks | Caseinate control | substitution | substitution |
| 0 | NO | NO | NO |
| 1 | NO | NO | NO |
| 2 | NO | NO | NO |
| 3 | NO | NO | NO |
| 4 | NO | NO | NO |
| 5 | NO | NO | NO |
| 6 | NO | NO | NO |
| 7 | NO | NO | NO |
| 8 | NO | NO | NO |

Tables 5, 6, and 7 demonstrate that all the coffee creamers tested showed acceptable stability in hot brewed coffee over the 8 week period measured. There was no noticeable feathering, oil drop formation, or protein instability in any of the tested samples. It is particularly notable that both the 50% and 1920% micellar casein coffee creamer made with 50 wt. % less protein or 1920% more micellar casein than the sodium caseinate control had comparable stability in both hot coffees over the 8 week period.

### Whitening Ability of Coffee Creamers in Coffee Samples

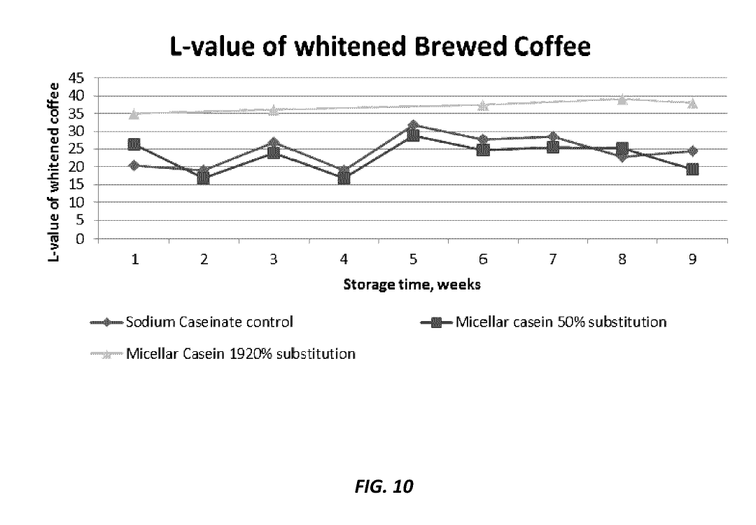

FIG. 10 is a graph measuring the whitening ability (i.e., L-value) of hot brewed coffee whitened with three different coffee creamers. The three creamers tested included (i) a sodium caseinate control creamer, and (ii) the present creamers made with micellar casein in amounts ranging from 50%, and 1920% of the protein weight of sodium caseinate used in the control. The whitening ability of the coffee creamers were recorded after the creamers were initially added and stirred into the hot brewed coffee. Creamers were evaluated at the initial production date (day 0) and again after 1 week, 2 weeks, 3 weeks, 4 weeks, 6 weeks, and 8 weeks.

FIG. 10 also demonstrates that all the coffee creamers tested showed acceptable whitening ability in hot brewed coffee over the 8 week period measured. It is particularly notable that the 50% micellar casein coffee creamer made with 50 wt. % less protein than the sodium caseinate control had similar whitening ability to the sodium caseinate control coffee over the 8 week period. Coffee made with the 1920% micellar casein coffee creamer made with 1920 wt. % more protein than the sodium caseinate control showed significantly more whitening ability than the sodium caseinate control and the 50% micellar casein coffee creamer. The enhanced whitening power is not entirely surprising in that native casein micelles contribute greatly to the whiteness of milk and the whitening ability is also exhibited in whitening coffee with coffee creamer containing higher levels of protein than a standard coffee creamer.

### Acidity Levels of Coffee Creamers Over Time

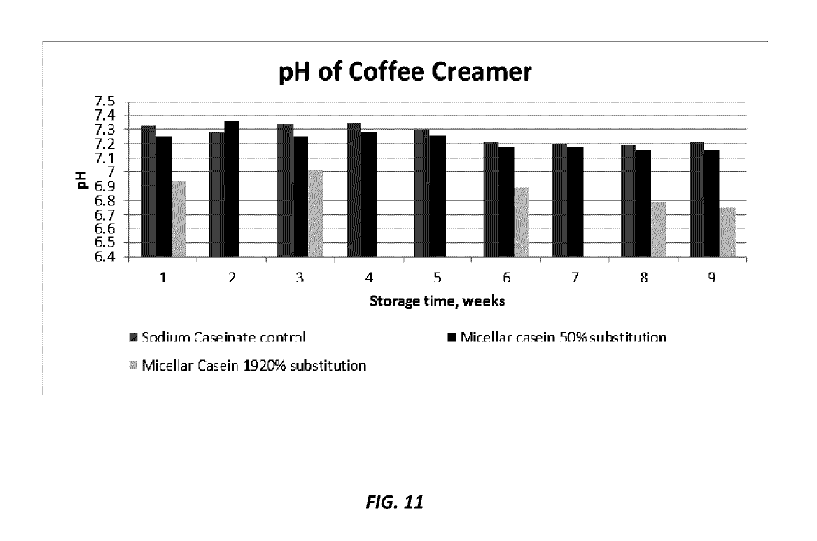

FIG. 11 is a graph measuring the pH of three different coffee creamers over a period of 8 weeks. The three creamers tested included (i) a sodium caseinate control creamer, and (ii) the present creamers made with micellar casein in amounts ranging from 50%, and 1920% of the protein weight of sodium caseinate used in the control. The pH of the coffee creamers were recorded at the time the creamers were produced (i.e., day 0), and again after 1 week, 2 weeks, 3 weeks, 4 weeks, 6 weeks, and 8 weeks. The graph shows coffee creamers made with sodium caseinate and 50% micellar casein had comparable pH stability over the 8 week period measured. The coffee creamer made with a higher level of micellar casein, 1920% more protein from micellar casein than the sodium caseinate control showed overall lower pH than the control or the 50% micellar casein creamer. The lower pH is to be expected because as the protein concentration increases in solutions there area greater number of hydrogen (H⁺) ions present in the solution which result in a lower measured pH. The sodium casein ate and micellar casein creamers showed a slight decrease in pH (increase in acidity) by approximately 0.1 to 0.2 over the 8 week period.

### Viscosity Levels of Coffee Creamers Over Time

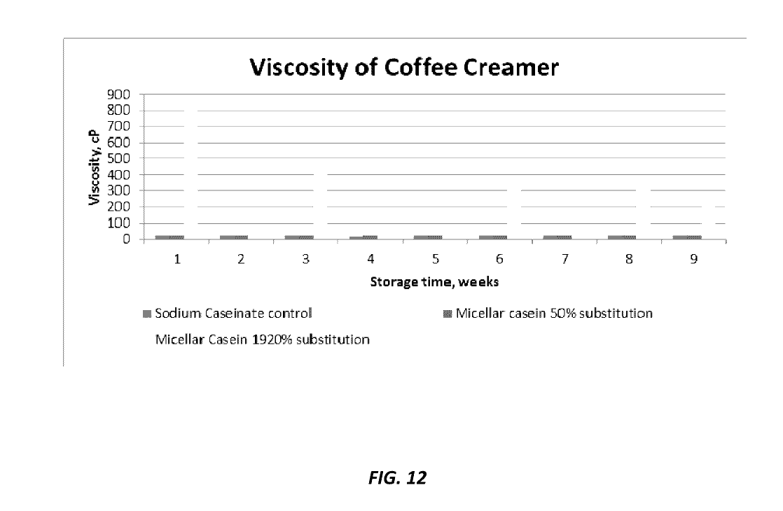

FIG. 12 is a graph measuring the viscosity of three different coffee creamers over a period of 8 weeks. The three creamers tested included (i) a sodium caseinate control creamer, and (ii) the present creamers made with micellar casein in amounts ranging from 50%, and 1920% of the protein weight of sodium caseinate used in the control. The viscosity of the coffee creamers were recorded at the time the creamers were produced (i.e., day 0), and again after 1 week, 2 weeks, 4 weeks, 6 weeks, and 8 weeks. The graph shows the sodium caseinate control and 50% micellar casein coffee creamers having comparable viscosity stability over the 8 week period measured. Creamer made with the highest level of micellar casein containing 1920 wt. % of the protein content in the sodium caseinate control had significantly higher viscosity across the measured time period. The high viscosity of the 1920% micellar casein creamer can be expected as the higher protein content of this creamer assures more casein to casein interaction as the intersticial space between micelles is reduced with increasing concentration. The sodium caseinate and 50% micellar casein creamers also exhibited a gradually increasing viscosity (about 1-2 cP) over the period measured.

### Particle Size Measurements for Coffee Creamers Over Time

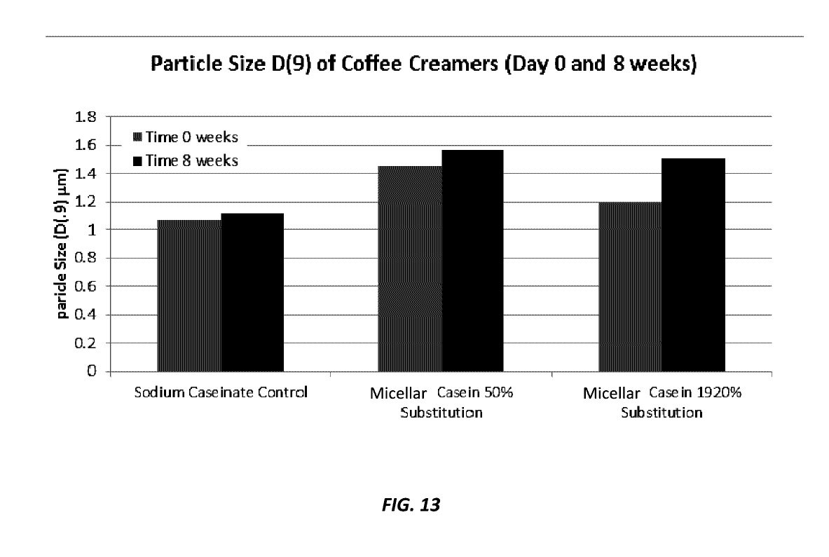

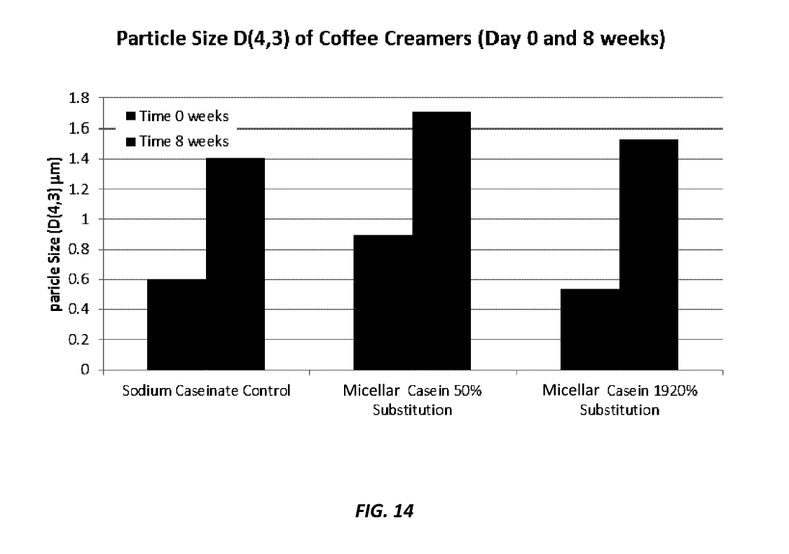

FIG. 13 is a graph measuring the value in which 90% of the particles in the creamers are smaller than approximately 9 μm for the three different coffee creamers analyzed. The particle measurements were taking upon the formation of the creamers and 8 weeks later. The three creamers tested included (i) a sodium caseinate control creamer, and (ii) the present creamers made with micellar casein in amounts ranging from 50%, and 1920% of the protein weight of sodium caseinate used in the control. FIG. 14 is a graph measuring the volume weighted mean of fat droplets in the same six coffee creamers, also at creation and 8 weeks later.

FIGS. 13 and 14 demonstrate that all the coffee creamers tested showed acceptable particle count size for both measurements over the 8 week period. This indicates that all three creamers form stable emulsions over this timeframe, and would have acceptable shelf-lives for liquid coffee creamers. The figures also show that as the total protein content of the creamer is decreased even by 50% when replacing the sodium caseinate protein with a reduced weight of micellar casein protein, the particle size increases. This may be explained by the fact that with less protein in the creamers to emulsify the fat particles, the average size of the particles is larger. Despite the larger average particle size, the reduced weight of micellar casein protein was still able to maintain stable emulsions over time. The larger particle size associated with the 1920% micellar casein coffee cream may be explained by the excess protein having greater protein to protein associations resulting in larger particles. The fact that there is an excess of protein available to emulsify the available fat one would expect that the fat droplets are of a normal or even slightly reduced size and that the abundance of protein is responsible for the particle size difference.

Having described several embodiments, it will be recognized by those of skill in the art that various modifications, alternative constructions, and equivalents may be used without departing from the spirit of the invention. Additionally, a number of well-known processes and elements have not been described in order to avoid unnecessarily obscuring the present invention. Additionally, details of any specific embodiment may not always be present in variations of that embodiment or may be added to other embodiments.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed. The upper and lower limits of these smaller ranges may independently be included or excluded in the range, and each range where either, neither, or both limits are included in the smaller ranges is also encompassed within the invention, subject to any specifically excluded limit in the stated range. Where the stated range includes one or both of the limits, ranges excluding either or both of those included limits are also included.

As used herein and in the appended claims, the singular forms “a”, “an”, and “the” include plural referents unless the context clearly dictates otherwise. Thus, for example, reference to “a method” includes a plurality of such methods and reference to “the dairy protein” includes reference to one or more dairy proteins and equivalents thereof known to those skilled in the art, and so forth. The invention has now been described in detail for the purposes of clarity and understanding. However, it will be appreciated that certain changes and modifications may be practice within the scope of the appended claims.

What is claimed is:

1. A nutritional composition comprising:
a casein compound comprising micellar casein;
a vegetable oil;
a sweetener; and
an acidity regulator.

2. The nutritional composition of claim 1, wherein the micellar casein is native micellar casein.

3. The nutritional composition of claim 1, wherein the casein compound is a microfiltered milk protein compound that comprises the micellar casein.

4. The nutritional composition of claim 1, wherein the casein compound consists essentially of the micellar casein.

5. The nutritional composition of claim 1, wherein the casein compound has substantially no caseinate compounds.

6. The nutritional composition of claim 1, wherein the nutritional composition is a liquid emulsion.

7. The nutritional composition of claim 6, wherein the liquid emulsion further comprises water.

8. The nutritional composition of claim 1, wherein the nutritional composition is a powder.

9. The nutritional composition of claim 1, wherein the vegetable oil comprises at least one oil chosen from soybean oil, cottonseed oil, palm oil, palm kernel oil, coconut oil, safflower oil, corn oil, sunflower oil and canola oil.

10. The nutritional composition of claim 1, wherein the sweetener comprises a carbohydrate.

11. The nutritional composition of claim 10, wherein the carbohydrate includes at least one carbohydrate chosen from sucrose, fructose, corn syrup solids, high-fructose corn syrup, dextrose, maltodextrin, brown sugar, and maple syrup.

12. The nutritional compound of claim 1, wherein the sweetener is a non-nutritive sweetener that includes at least one of sucralose, aspartame, saccharin, stevia, monk fruit extract, neotame, advantame, and acesulfame potassium.

13. The nutritional composition of claim 1, wherein the sweetener comprises a sugar alcohol.

14. The nutritional composition of claim 1, wherein the acidity regulator comprises a phosphate salt.

15. The nutritional composition of claim 14, wherein the phosphate salt comprises dipotassium phosphate.

16. The nutritional composition of claim 1, wherein the nutritional compound further comprises a stabilization agent that keeps the nutritional compound homogenized.

17. The nutritional composition of claim 16, wherein the stabilization agent comprises one or more compounds chosen from monoglycerides, diglycerides, lactylated monoglycerides, lecithin, sodium stearoyl lactylate, polysorbates, carrageenan, cellulose gum, guar gum, and cellulose gel.

18. The nutritional composition of claim 1, wherein the nutritional composition is a powder and further comprises an anti-caking agent.

19. The nutritional composition of claim 18, wherein the anti-caking agent comprises at least one anti-caking agent chosen from silicon dioxide and sodium aluminosilicate.

20. The nutritional composition of claim 1, wherein the nutritional composition is a beverage whitener.

21. The nutritional composition of claim 20, wherein the beverage whitener is a coffee creamer or tea creamer.

22. A nutritional composition comprising on a dry basis:
1 wt. % to 15 wt. % casein compound comprising micellar casein;
10 wt. % to 50 wt. % vegetable oil;
15 wt. % to 70 wt. % sweetener; and
0.5 wt % to 5 wt. % acidity regulator.

23. The nutritional composition of claim 22, wherein the micellar casein is native micellar casein.

24. The nutritional composition of claim 22, wherein the casein compound is a microfiltered milk protein compound that comprises the micellar casein.

25. The nutritional composition of claim 22, wherein the casein compound consists essentially of the micellar casein.

26. The nutritional composition of claim 22, wherein the casein compound has substantially no caseinate compounds.

27. The nutritional composition of claim 22, wherein the nutritional compound further comprises a stabilization agent that keeps the nutritional compound homogenized.

28. The nutritional composition of claim 22, wherein the nutritional composition further comprises an anti-caking agent.

29. The nutritional composition of claim 22, wherein the nutritional composition is a beverage whitener.

30. The nutritional composition of claim 29, wherein the beverage whitener is a coffee creamer or tea creamer.

31. A coffee creamer comprising:
an oil; and
a casein compound consisting essentially of micellar casein.

32. The coffee creamer of claim 31, wherein the micellar casein is native micellar casein.

33. The coffee creamer of claim 31, wherein the casein compound is a microfiltered milk protein compound that comprises the micellar casein.

34. The coffee creamer of claim 31, wherein the coffee creamer further comprises a sweetener.

35. The coffee creamer of claim 31, wherein the coffee creamer further comprises an acidity regulator.

36. The coffee creamer of claim 31, wherein the coffee creamer further comprises a stabilization agent.

37. The coffee creamer of claim 31, wherein the coffee creamer further comprises an anti-caking agent.

38. The coffee creamer of claim 31, wherein the coffee creamer is a liquid emulsion.

39. The coffee creamer of claim 31, wherein the coffee creamer is a powder.

40. A nutritional composition comprising:
a casein compound comprising micellar casein;
a vegetable oil;
a sweetener; and
an acidity regulator,
wherein a protein content of the nutritional composition has been reduced by 10% to 50%.

41. A nutritional composition comprising:
a casein compound comprising micellar casein;
a vegetable oil;
a sweetener; and
an acidity regulator,
wherein a protein content of the nutritional compound has been increased by 100 to 4000%.

42. A method of making micellar casein, the method comprising:
filtering milk to make to make a milk retentate;
ultrafiltering the milk retentate to make an ultrafiltered retentate;
subjecting the ultrafiltered retentate to a purification process to make a purified ultrafiltered retentate, wherein the purification process is chosen from at least one of:
(i) nanofiltration, and
(ii) evaporation; and
drying the purified ultrafiltered retentate to make the micellar casein.

43. The method of claim 42, wherein the milk is chosen from skim milk, whole milk, reduced-fat milk, and low-fat milk.

44. The method of claim 43, wherein the milk is skim milk.

45. A method of making a nutritional composition, the method comprising:
providing one or more initial ingredients;
forming the initial ingredients into an aqueous mixture;
combining a casein compound with the aqueous mixture to form a casein-containing mixture;
blending a fat or oil with the casein mixture to form a pre-emulsion;
homogenizing the pre-emulsion into a homogenized emulsion; and
processing the homogenized emulsion into the nutritional composition.

46. The method of claim 45, wherein the nutritional composition is a beverage creamer.

47. The method of claim 45, wherein the casein compound is micellar casein.

48. The method of claim 45, wherein the homogenizing of the pre-emulsion comprises:
preforming an initial homogenization of the pre-emulsion to form a partially homogenized emulsion;
heating the partially homogenized emulsion; and
performing a final homogenization of the heated, partially homogenized emulsion to form the homogenized emulsion.

48. The method of claim 45, wherein the processing of the homogenized emulsion comprises spray drying the homogenized emulsion to form a powdered composition that is the nutritional composition.

49. The method of claim 45, wherein the homogenized emulsion is a liquid emulsion, and the processing of the homogenized emulsion comprises packaging the liquid emulsion.

50. The method of claim 45, wherein the one or more initial ingredients comprise at least one of:
a vegetable oil;
a sweetener; and
an acidity regulator.
